(19) United States
(12) Patent Application Publication
(10) Pub. No.: US 2015/0064477 A1
(43) Pub. Date: Mar. 5, 2015

(54) Bend Stiffener

(71) Applicant: Balmoral Comtec Limited, Aberdeen (GB)

(72) Inventors: Robert Kenneth Oram, Aberdeen (GB); Kenneth James Toole, Lancaster (GB)

(73) Assignee: Balmoral Comtec Limited, Aberdeen (GB)

(21) Appl. No.: 14/474,585

(22) Filed: Sep. 2, 2014

(30) Foreign Application Priority Data
Sep. 2, 2013 (GB) 1315602.1

(51) Int. Cl. C09D 175/08; B05D 1/02

(52) U.S. Cl. CPC C09D 175/08; B05D 1/02
USPC 428/423.3; 252/589; 524/590; 427/160

(57) ABSTRACT

A UV-resistant coating composition for protecting polyurethane surfaces, especially in a marine environment above the sea-air interface (so-called “splash zone”), is formed from an amorphous hydrophobic dimer fatty acid-based polyether polyol and an aliphatic isocyanate, such as hexamethylene diisocyanate, and may include a UV blocking agent such as titanium dioxide. The polyol may be modified with a chain extender. The composition provides an elastomeric protective barrier against the deleterious effects of UV exposure, and is useful on polyurethane surfaces on bend stiffeners, buoys etc.

### BACKGROUND TO THE DISCLOSURE

Bend stiffeners are primarily used to provide over-bend protection to the fixed or anchored end parts of flexible subsea conduits (commonly referred to as overbend protection). Stiffeners may be custom-moulded in grades of polyurethane elastomer specifically developed for this purpose. Stiffeners can be designed for static or dynamic applications.

Dynamic bend stiffeners are subjected to demanding forces and constant movement during the service life of the product they are protecting, which may be about 25 years. Typically, a flexible conduit such as an umbilical, power cable, flexible flowline or flexible riser has its topside and subsea ends fitted to rigid interface structures on a surface or subsea facility, for example on a floating vessel such as a FPSO production unit, or at a subsea site such as a pipeline end termination (PLET) or a mid-water arch. The tidal and environmental forces acting on such subsea conduits cause constant flexing. This flexing, when combined with axial (tensile) loads, can cause the subsea conduit to become damaged. One function of a dynamic bend stiffener is to prevent or at least mitigate such damage and prolong service life by adding localised and progressively-increasing stiffness at the fixed ends. By this measure it is intended to continuously maintain the induced bend stresses and flex angles within acceptable limits.

Service life of a polyurethane bend stiffener exposed to sunlight can be shortened due to the deleterious effects of ultra-violet light (UV hereinafter).

The grades of polyurethane elastomer with the necessary mechanical performance and also with the required fatigue resistance for dynamic bend stiffener use are very limited: essentially all are of the PTMEG polyurethane type (PTMEG is a polytetramethylene ether glycol chain extender (‘polyol’) which gives the required mechanical and fatigue performance). The polyol is reacted with a multifunctional isocyanate to produce the final polyurethane. The only isocyanates found to be suitable for bend stiffener manufacture are methylene diphenyl diisocyanate (MDI) and toluene di-isocyanate (TDI). Both of these materials contain aromatic rings which can absorb UV light and therefore potentially these materials would be susceptible to photo-oxidative degradation.

Proposals to address such potential problems by including UV scavenger materials to absorb incident UV, or to use sacrificial overcoats of standard polyurethane and polyurea elastomers are not free of potential problems.

It is difficult to design a scavenging system which, whilst being progressively consumed by sacrificial UV degradation, is guaranteed to remain effective for a sufficient period of time, for example 25 years. The rate of depletion of an additive to be used in any such scavenger system will vary significantly depending upon specific environmental conditions of temperature and UV intensity.

Furthermore, damage to a protective overcoat such as cracks might propagate into the material to be protected when using bonded overcoats, or at least expose the underlying material to UV. Use of “unbonded” overcoats appears to avoid crack propagation risks but an unbonded overcoat must be attached to the underlying surface at some position, otherwise the overcoat could be displaced during flexing of the undersurface. Flexure may create high tensile stresses in the overcoat material, which will actually increase the likelihood of full-thickness cracking and failure of the protection overcoat.

### SUMMARY OF THE DISCLOSURE

A bend stiffener to be more particularly described hereinbelow has a flexible protective coating to inhibit deleterious effects of exposure of the bend stiffener to ultra violet light (UV). The protective coating comprises a reaction product of at least one polyol resin and at least one aliphatic isocyanate. The polyol resin may be an hydrophobic polyol. Suitable hydrophobic polyols are based upon, or derivatives of C₃₆ dimerised fatty acids and diols. Commercially available materials of a suitable type include Priplast 1837, Priplast 1838, Priplast 1839 and Pripol 2033 from Croda Europe. Optionally, chain extenders such as 1,4 butane diol, may be used used at 1-10% on the polyol. Suitable aliphatic isocyanates include hexamethylene diisocyanate adducts such as those available commercially as Asahi Kasei Duranate E402-100 and Bayer Desmodur N3900.

The combination of one or more of the polyol and aliphatic isocyanates when reacted under appropriate polymerisation conditions of temperature and in the presence of appropriate primary catalysts such as Dow Acima Metatin 1230 and amine back-end catalysts such as BASF Lupragen N-201 yields a flexible, water-resistant, elastomeric material which, as well as being itself substantially immune to UV degradation, provides a UV-penetration inhibiting barrier suitable to be applied to a UV-sensitive polyurethane product. The coating may include additives or dopants to enhance one or more properties thereof. A UV-blocking agent such as a dispersion of titanium dioxide in ether triol may be incorporated to further supplement the blocking protection against through-thickness UV penetration.

The contemplated protective coating of a reaction product of at least one polyol resin and at least one aliphatic isocyanate may be fully bonded to the surface to be protected.

The coating obviates or mitigates the deleterious effects of UV exposure, i.e. photo-oxidation and the consequences thereof. The degradation of unprotected aromatic isocyanate based polyurethane bend stiffener surfaces by UV absorption is evinced by the photochemically-initiated degradation to chromophoric groups that are highly coloured. Colour changes from the natural PU polymer colour of pale yellow to brown are observed. Pigmented coatings will give clearer evidence of this change as the colour deepens or changes to another, e.g. blue to green. Discolouration, crazing and cracking displayed on a bend stiffener surface are indications of a weakened bend stiffener that is susceptible to ultimate potentially catastrophic failure.

### DISCLOSURE OF EMBODIMENTS

A dynamic bend stiffener may comprise a polymer composition body, which has a space within the body to accommodate an elongate article such as a riser. The space within the body is designed to accommodate any flexible elongate article such as an umbilical or tubular pipe. The space may also accommodate any of a fluid conduit, tubing, power cable, communications bundle, hydraulic lines, auxiliary line etc. to be tethered between a subsea site and a surface facility, whereby the flexible elongate article is subject to axial and bending loads in use.

The space may be aligned with the longitudinal axis of the dynamic bend stiffener and normally takes the form of a bore that extends from a tapered tip of the dynamic bend stiffener throughout its length to a wider base of the dynamic bend stiffener.

The body has an overcoat of a flexible elastomeric UV-inhibitor material applied to unshielded external stiffener surfaces liable to be exposed to UV in normal use.

The base of the dynamic bend stiffener may be provided with, or adapted to receive, a fastener or latching mechanism or interface structure, and optionally has a protective liner according to the contemplated use. The body may have structural reinforcement such as ribbing or inserted reinforcing elements, especially in the base of the dynamic bend stiffener. The bend stiffener is of generally conical shape, typically a truncated cone.

### Materials:

The body of the bend stiffener may comprise a polyurethane formed from urethane forming resins, and using a catalyst or curing agent to promote or participate in the polymerisation reaction. Since the required mechanical performance and fatigue resistance demands on the bend stiffener are high, suitable polyurethanes are to be found amongst polytetramethylene ether glycol (PTMEG) modified types of polyurethane elastomers. PTMEG is produced by cationic polymerisation of tetrahydrofuran (THF) and is available commercially. Use of a suitable multifunctional isocyanate, such as methylene diphenyl diisocyanate or toluene diisocyanate yields an elastomeric polyurethane which can be shaped, for example cast, to form a bend stiffener body structure.

An illustrative example of a bend stiffener and a process for manufacturing a body for a bend stiffener is described in GB2040014. Other patent publications disclosing bend-stiffeners include EP0859182, and GB2492109.

Polyurethane based bend stiffeners are potentially susceptible to ultimate ultra-violet (UV) induced failures. Such failures could be attributed to degradation of polymers. It is possible that urethane and aromatic functionality within the surface layer is replaced by amino, carbonyl and azo groups. In the polyether segment, the polyol chain may break with formation of low molecular weight fragments that are lost slowly from the polyurethane body. It is postulated that this slow loss of polymer creates shrinking in polymer volume which can initiate crazing in the surface.

These changes in the molecular structure of the polyurethane chains lead to changes in mechanical performance, including reduced fatigue resistance. The crazes which inevitably develop on the exposed surface can, under suitable conditions, propagate into cracks which in turn would lead to catastrophic failure of the bend stiffener.

Therefore protection of the bend stiffener exposed surfaces is provided for in this disclosure.

Surfaces of the body which will be unshielded and exposed to UV in use, for example deployed above the splash zone but below the vessel/rig deck level, and thereby susceptible to deleterious effects of such UV exposure are to be protected by a coating composition formed from reaction of at least one polyol resin with at least one aliphatic isocyanate.

Suitable polyols include: amorphous hydrophobic dimer fatty acid based polyether polyols. These may be, for example, derivatives based upon C₃₆ dimerised fatty acids and diols. The following materials may be used:
Croda Priplast 1837, (MW 1000), Croda Priplast 1838, (MW 2000); and
Croda Priplast 1839 (MW 2000) and Croda Pripol 2033 (MW 540).

Appropriate aliphatic isocyanates include:
Asahi Kasei Duranate E402-100 (a hexamethylene diisocyanate-based polyisocyanate); and
Bayer Desmodur N3900, (a hexamethylene diisocyanate-based polyisocyanate)

### Methods:

A UV resistant coating composition may be formed from two components: a hydrophobic dimer fatty acid based polyether polyol and a hexamethylene diisocyanate-based polyisocyanate. These components may be introduced to a spray coating device after pre-heating to promote reaction. The coating composition may be applied to the body of a prepared dynamic bend stiffener by spraying. The two components may be intimately mixed in a spray head after pre-heating to 70 deg C. (Polyol side) and 50 deg C. (Isocyanate side). A spray rate of 3.5 kg/min has been found to be suitable.

The spray is preferably applied onto the surface of a pre-manufactured bend stiffener, after suitable cleaning and preparation of the bend stiffener surface, optionally followed by application of an interface primer (for example CIL Cilbond 41 or Dow Hyperlast 016) and pre-heating to nominal 50 deg C.

A coating may be applied at any thickness required, but generally a thickness of about 2 mm is sufficient. It is not considered that a thickness greater than about 4 mm is necessary.

### Uses:

Although primarily designed to provide protection against photo-degradation of bend stiffeners, the overcoat spray PU system herein described can be used to provide similar protection to any PU product or PU coating otherwise exposed to UV degradation in those situations where such degradation would be deleterious to product performance. A standard white (based on titanium dioxide, an inorganic opacifier) UV-blocking system can be supplemented with, or substituted by similarly-effective, coloured pigments to meet service requirements, for example for surface colour preservation on navigation channel marker buoys.

Variations, modifications of the disclosed embodiments contemplated by the person skilled in the field are within the scope of the disclosure, and with regard to scope, attention is directed to the following claims which form part of the present disclosure and extend to all equivalents of the disclosed subject matter.

1. A UV-resistant composition comprising a reaction product of at least one polyol and at least one aliphatic isocyanate.

2. The UV-resistant composition as claimed in claim 1, wherein the polyol is an hydrophobic polyol.

3. The UV-resistant composition as claimed in claim 1 or claim 2, wherein the polyol comprises a derivative of C₃₆ dimerised fatty acids and diols.

4. The UV-resistant composition as claimed in claim 1, wherein the polyol is extended using a chain extender such as 1,4 butane diol.

5. The UV-resistant composition as claimed in claim 1, wherein the aliphatic isocyanates comprise hexamethylene diisocyanate adducts.

6. The UV-resistant composition as claimed in claim 1, wherein the UV-resistant composition contains a UV blocking agent such as titanium dioxide.

7. A method of conferring UV-protection upon a surface comprising the application of a UV-resistant composition as claimed in claim 1 to the surface.

8. A method of protecting a bend stiffener comprising polyurethane surfaces against UV degradation comprising the application of a UV-resistant composition as claimed in claim 1 to a polyurethane surface of the bend stiffener.

9. The method as claimed in either claim 7 or claim 8, wherein the UV-resistant composition is applied by spraying.

10. The method as claimed in claim 9, wherein at least one polyol and at least one aliphatic isocyanate are separately heated prior to application and applied together through a spray device.

11. A bend stiffener comprising polyurethane surfaces coated with a UV-resistant composition comprising a reaction product of at least one polyol and at least one aliphatic isocyanate.

12. The bend stiffener as claimed in claim 11, wherein the polyol comprises a derivative of C₃₆ dimerised fatty acids and diols.

13. The bend stiffener as claimed in claim 11 or claim 12, wherein the polyol is extended using a chain extender such as 1,4 butane diol.

14. The bend stiffener as claimed in claim 11, wherein the aliphatic isocyanates comprise hexamethylene diisocyanate adducts.

15. The bend stiffener as claimed in claim 11, wherein the UV-resistant composition contains a UV blocking agent such as titanium dioxide.
